(19) United States
(12) Patent Application Publication
(10) Pub. No.: US 2014/0214632 A1
(43) Pub. Date: Jul. 31, 2014

(54) Smart Crowd Sourcing On Product Classification

(71) Applicant: WAL-MART STORES, INC., Bentonville, AR (US)

(72) Inventors: Nikesh Lucky Garera, Mountain View, CA (US); Narasimhan Rampalli, Los Altos, CA (US); Dintyala Venkata Subrahmanya Ravikant, San Bruno, CA (US); Srikanth Subramaniam, San Jose, CA (US); Chong Sun, Redwood City, CA (US); Heather Dawn Yalin, Alameda, CA (US)

(73) Assignee: Wal-Mart Stores, Inc., Bentonville, AR (US)

(21) Appl. No.: 13/756,479

(22) Filed: Jan. 31, 2013

(51) Int. Cl. G06Q 10/08

(52) U.S. Cl. CPC G06Q 10/087
USPC 705/28

(57) ABSTRACT

The present disclosure extends to methods, systems, and computer program products for updating a merchant database with new products in an optimized manner using both computer based classification models and human involvement in a smart crowd source environment.

### BACKGROUND

Retailers often have databases and warehouses full of thousands upon thousands of products offered for sale, with new products being offered every day. The databases must be updated with these new products in an organized and usable manner. Each product and new product item should be categorized within the database so that it can be found by customers for purchase or employees for stocking. The large number of products offered for sale by a merchant makes updating a merchant's product database difficult and costly with current methods and systems.

These problems apply even with the use of computers and current computing systems and often require human involvement to achieve acceptable accuracy, but human involvement is expansive. The disclosed methods and systems herein, provide more efficient and cost effective methods and systems for merchants to keep product databases up to date with new product offerings. Methods and systems disclosed involve computer program products for updating a merchant database with new products in an optimized manner, using both computer based classification models and human involvement in a smart crowd source environment.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings where:

FIG. 1 illustrates an example block diagram of a computing device;

FIG. 2 illustrates an example retail location and computer architecture that facilitates different implementations described herein;

FIG. 3 illustrates a flow chart of an example method according to one implementation; and

FIG. 4 illustrates an implementation of a method in accordance with the disclosed methods and systems.

### DETAILED DESCRIPTION

The present disclosure extends to methods, systems, and computer program products for optimizing the need for human involvement in updating a merchant database with new product items. In the following description of the present disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure.

Implementations of the present disclosure may comprise or utilize a special purpose or general-purpose computer including computer hardware, such as, for example, one or more processors and system memory, as discussed in greater detail below. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. It should be noted that any of the above mentioned computing devices may be provided by or located within a brick and mortar location. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS), and deployment models (e.g., private cloud, community cloud, public cloud, hybrid cloud, or any suitable service type model now known to those of ordinary skill in the field, or later discovered). Databases and servers described with respect to the present disclosure can be included in a cloud model.

As used herein, the terms “smart crowd sourcing” and “crowdsourcing” are used interchangeably, and are intended to denote a community of computer users that perform data related tasks in mass. Users or members of a crowd sourcing community may be representatives of a merchant, or may be contracted to do desired tasks. The crowd sourcing members may be connected to a merchant's computing system over a network.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

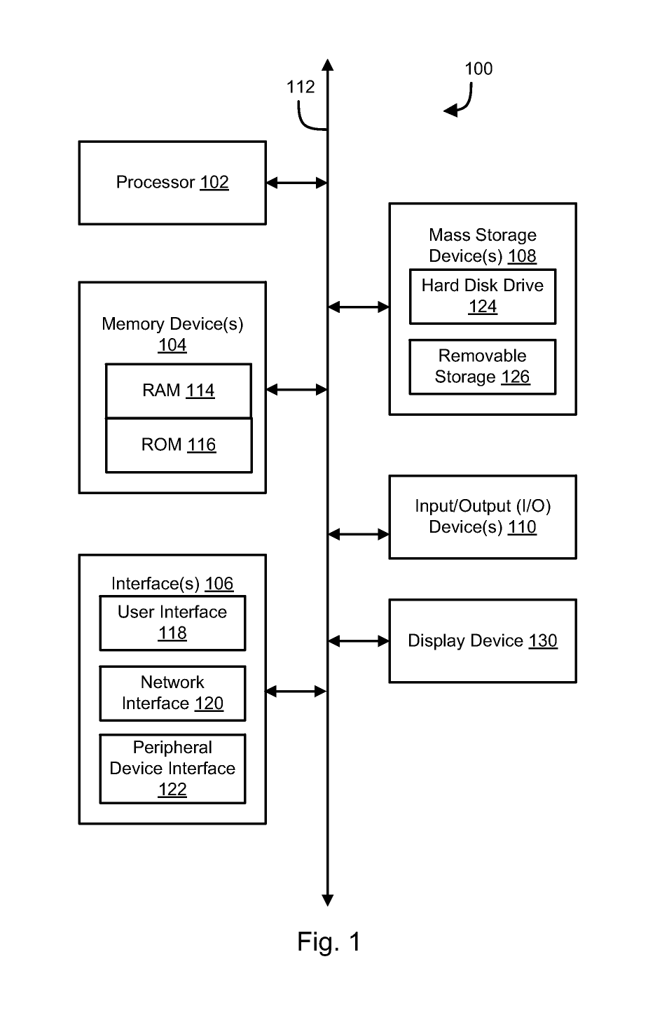

FIG. 1 is a block diagram illustrating an example computing device 100. Computing device 100 may be used to perform various procedures, such as those discussed herein. Computing device 100 can function as a server, a client, or any other computing entity. Computing device can perform various monitoring functions as discussed herein, and can execute one or more application programs, such as the application programs described herein. Computing device 100 can be any of a wide variety of computing devices, such as a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer readable media, such as magnetic tapes, magnetic disks, optical disks, solid-state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 may include any number of different network interfaces 120, such as interfaces to local area networks (LANs), wide area networks (WANs), wireless networks, and the Internet. Other interface(s) include user interface 118 and peripheral device interface 122. The interface(s) 106 may also include one or more user interface elements 118. The interface(s) 106 may also include one or more peripheral interfaces such as interfaces for printers, pointing devices (mice, track pad, etc.), keyboards, and the like.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 100, and are executed by processor(s) 102. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

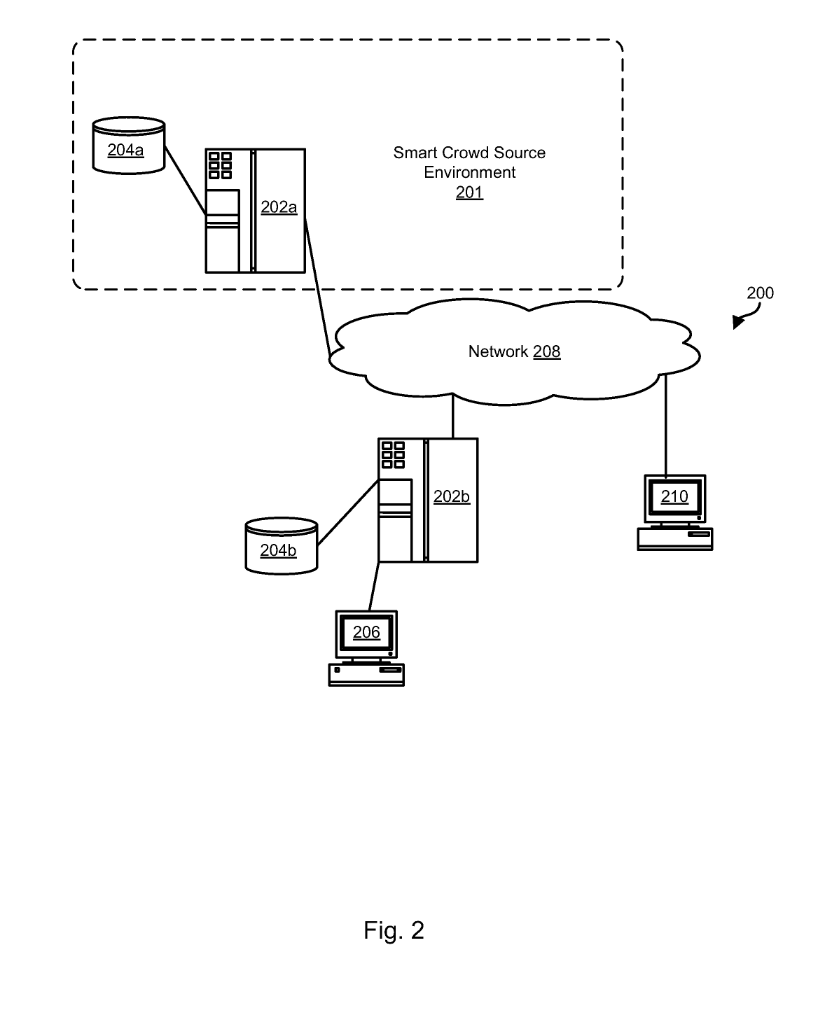

FIG. 2 illustrates an example of a computing environment 200 and a crowd sourcing environment 201 suitable for implementing the methods disclosed herein. In some implementations, a server 202a provides access to a database 204a in data communication therewith, and may be located and accessed within a brick and mortar retail location. The database 204a may store customer attribute information such as a user profile as well as a list of other user profiles of friends and associates associated with the user profile. The database 204a may additionally store attributes of the user associated with the user profile. The server 202a may provide access to the database 204a to users associated with the user profiles and/or to others. For example, the server 202a may implement a web server for receiving requests for data stored in the database 204a and formatting requested information into web pages. The web server may additionally be operable to receive information and store the information in the database 204a.

A server 202b may be associated with a merchant or by another entity or party providing databae updating services. The server 202b may be in data communication with a database 204b. The database 204b may store information regarding various products. In particular, information for a product may include a name, description, categorization, reviews, comments, price, past transaction data, and the like. The server 202b may analyze this data as well as data retrieved from the database 204a in order to perform methods as described herein. An operator or customer/user may access the server 202b by means of a workstation 206, which may be embodied as any general purpose computer, tablet computer, smart phone, or the like.

The server 202a and server 202b may communicate with one another over a network 208 such as the Internet or some other local area network (LAN), wide area network (WAN), virtual private network (VPN), or other network. A user may access data and functionality provided by the servers 202a, 202b by means of a workstation 210 in data communication with the network 208. The workstation 210 may be embodied as a general purpose computer, tablet computer, smart phone or the like. For example, the workstation 210 may host a web browser for requesting web pages, displaying web pages, and receiving user interaction with web pages, and performing other functionality of a web browser. The workstation 210, workstation 206, servers 202a-202b, and databases 204a, 204b may have some or all of the attributes of the computing device 100.

It is to be further understood that the phrase “computer system,” as used herein, shall be construed broadly to include a network as defined herein, as well as a single-unit work station (such as work station 206 or other work station) whether connected directly to a network via a communications connection or disconnected from a network, as well as a group of single-unit work stations which can share data or information through non-network means such as a flash drive or any suitable non-network means for sharing data now known or later discovered.

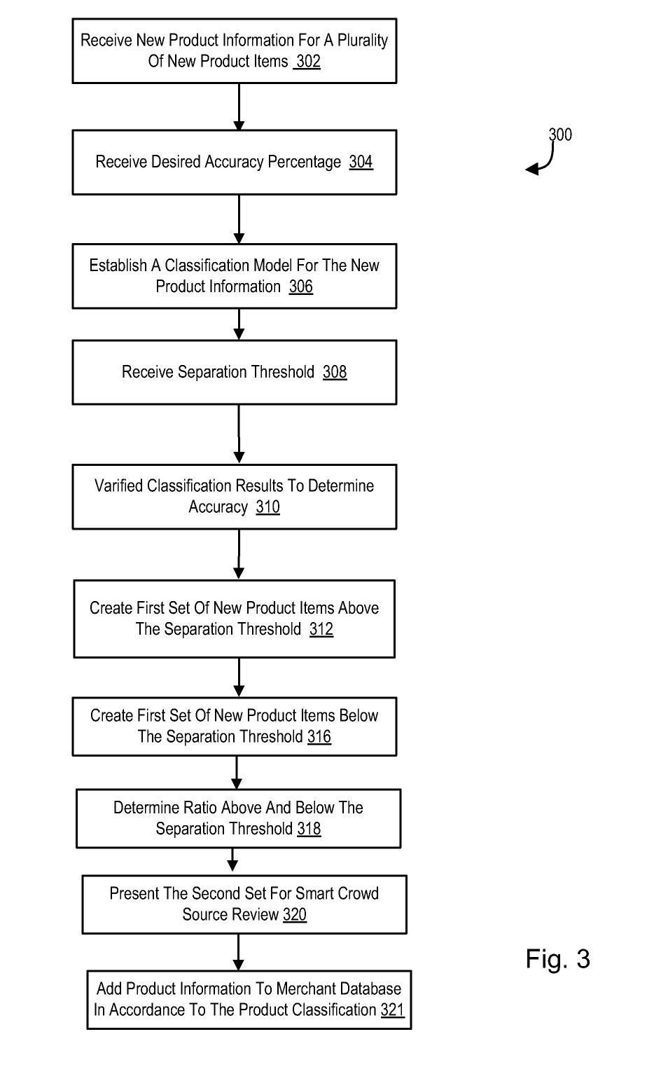

With reference primarily to FIG. 3, an implementation of a method 300 for updating a merchant's database through semantic product classification with optimized human involvement will be discussed. FIG. 1 and FIG. 2 may be referenced secondarily during the discussion in order to provide hardware support for the implementation. The disclosure aims to disclose methods and systems to allow a new product item to be automatically and efficiently added to a product database with the desired accuracy while managing the need for human review and input. For example, a product item may have a description and title associated with it that contains terms and values that can be quantified by a computer performing at least one classification model such that the new product item can be accurately categorized within a merchant's database. In an implementation the title and description may be combined to supply quantifiable information that may be used to analyze and classify a plurality of product items so that they can properly be categorized within a database automatically by a computer running a classification model.

The method 300 may be performed on a system that may include the database storage 204a (or any suitable memory device disposed in communication with the network 208) receiving new product item information at 302 representing a plurality of new product items to be sold by a merchant. The product item information may be stored in memory located within computing environment 200 for later classification by classification model. The product item information may be received into the computing environment in digital form from an electronic database in communication with the merchant's system. Additionally, the new product item information may be manually input by a user connected electronically with the computing environment 200. The new product item information may comprise a title, a description, parameters of use and performance, and any other suitable information associated with the plurality of product items that may be of interest in a merchant environment for identifying, quantifying and categorizing a plurality of new product items.

At 304, the system may receive a desired accuracy percentage that the classification model must meet for at least some of the new product classifications. It should be noted that it can be assumed that if a human was doing the classification the accuracy of the classification would be nearly 100% correct, while a classification model performed by a computer would have an accuracy percentage range between 75% and 97% depending upon the new product item being classified. As stated above, human involvement is costly and classification models may typically be more cost effective. However, classification models may work better for some product types than others, and so the classification model may be selected in order to best suit the product type of the item being classified.

At 306, a classification model may be established within the computing environment 200 for classifying the plurality of new product items. The classification model may be used within the computing environment 200 to quantify properties of the new product items by performing an algorithm or series of algorithms against the text properties (titles, description terms, images) provided in the new product item information received at 302 in order to quantify and ultimately classify the new product item relative to existing products items already in a merchant's database. Examples of classification models are: Naïve Bayes, K-Nearest-Neighbors, SVM, logistic regression, and multiclass perceptron, or the like. It should be understood that any classification model that is known or yet to be discovered is to be considered within the scope of this disclosure. It is to be contemplated that the first classification model may comprise a single algorithm or a plurality of algorithms as desired to classify the new product item. As discussed above, the product type may influence the classification model used or established at 306 within the system.

At 308, the system may receive a desired separation threshold that may be used by the system to determine how many of the new product items must be accurately classified at the specified accuracy percentage received at 304. The separation threshold may be a multiplier thereby influencing the classification model during operation of the system and may be arbitrarily chosen for it to have the desired influence within the method over the number of new products needing further human involvement to properly classify.

At 310, the results of the classification model may be verified for accuracy. Accuracy verification may be made by testing the classification against known standards of existing product items of the same product type within the merchant database as that of the new product items.

At 312, a first set of new product items is created for those items that were classified accurately at 310 as conforming to the accuracy percentage received at 304 and are above the separation threshold received at 308. At 314, a second set of new product items is created for those items that were classified accurately at 310 as conforming to the accuracy percentage received at 304 and are below the separation threshold received at 308.

At 318, a ratio of the number of new product items in the first set over the number of new product items in the second set may be determined in order to show the effectiveness of the classification model. The ratio may also be used to estimate the amount of human involvement that will be required to reach the classification accuracy standard for the new product items.

At 320, the second set of classifications for the new product items may be presented to a plurality of users with a smart crowd source environment for smart crowd source review. The smart crowd source review may be used to check the new product classifications created at 306 for accuracy and relevancy. For example, a new product item may be car tires for a scale model of a popular automobile that a merchant also provides tires for. If by chance that the classification models missed markers (such as key words, codes, images, or other machine recognizable data) in the new product item information that denoted the tires were for a scale model, the scale model tires may appear in the merchant's data base as full size tires for an actual automobile. A smart crowd user could readily spot such an anomaly and provide corrective information. Any smart crowd corrections may be added to the product classification and stored within memory of the computing environment 200. It should be noted that the smart crowd users may be connected over a network, or may be located within a brick and mortar establishing owned by the merchant. The smart crowd users maybe employees and representatives of the merchant, or may be outsourced to smart crowd communities.

At 321, the new product item may be added to the merchant database and properly categorized relative to existing products within the merchant database based on its classification. As can be realized from the discussion above, a merchant can efficiently and cost effectively add a plurality of new product items to a merchant database in an accurate and controlled manner by practicing the method 300 which takes advantage of, and influences, the automatic classification processes performed within the computing system 200 before enlisting involvement.

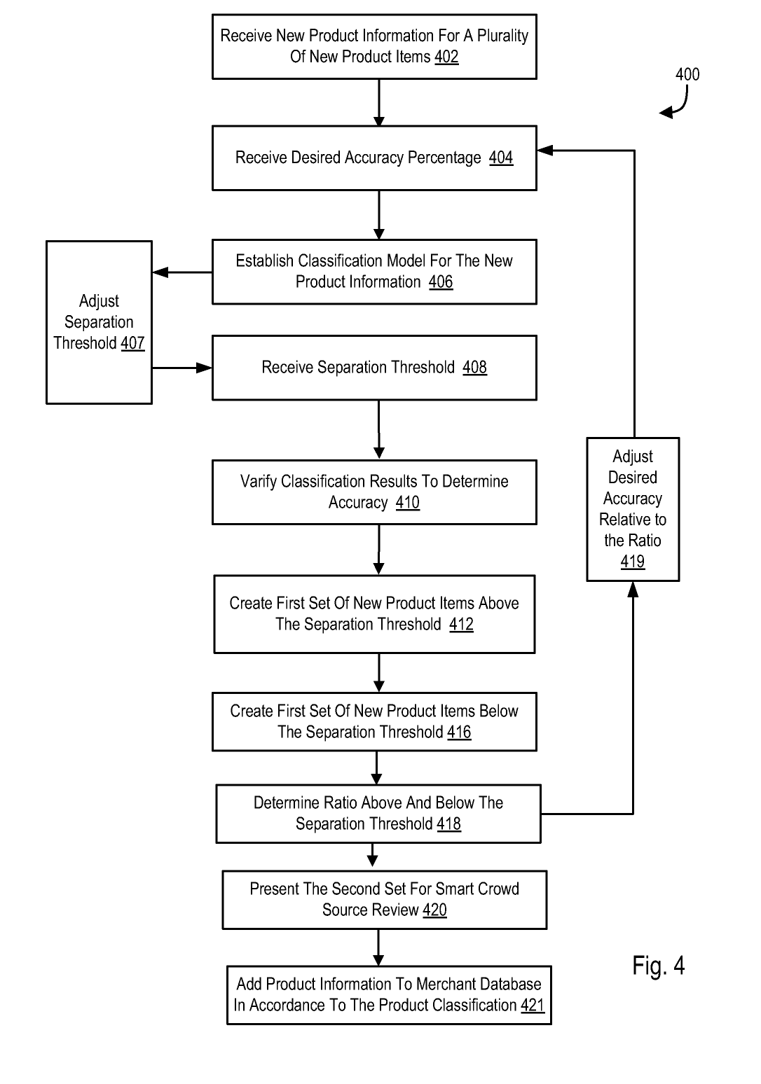

With reference primarily to FIG. 4, an implementation of a method 400 for updating a merchant's database through semantic product classification with minimal and controlled human involvement will be discussed. FIG. 1 and FIG. 2 may be referenced secondarily during the discussion in order to provide hardware support for the implementation. The disclosure aims to disclose methods and systems to allow a plurality of new product items to be automatically and efficiently added to a product database with minimal human involvement. For example, a plurality of product items may each have a description and title associated with it that contains terms and values that can be quantified by a computer performing at least one classification model such that the new product item can be accurately categorized within a merchant's database. In an implementation, the title and description may be combined to supply quantifiable information that may be used to analyze and classify a product item so that it can properly be categorized within a database automatically without human involvement, or alternatively with limited human involvement.

The method 400 may be performed on a system that may include the database storage 204a (or any suitable memory device disposed in communication with the network 208) receiving new product item information at 402 representing a plurality of new product items to be sold by a merchant. The product item information may be stored in memory located within computing environment 200 for later classification by a classification model. The product item information may be received into the computing environment in digital form from an electronic database in communication with the merchant's system. Additionally, the new product item information may be manually input by a user connected electronically with the computing environment 200. The new product item information may comprise a title, a description, parameters of use and performance, and any other suitable information associated with the product that may be of interest in a merchant environment for identifying, quantifying and categorizing a plurality of new product items.

At 404, the system may receive a desired accuracy percentage that the classification model must meet for at least some of the new product classifications. It should be noted that it can be assumed that if a human was doing the classification, the accuracy of the classification might be nearly 100% correct, while in contrast a classification model performed by a computer might be expected to only have an accuracy percentage range, for example, between 75% and 97% dependent upon the new product item being classified. Classification models may typically work better for some product types than others, thus the classification model may be selected to best suit the product type of the item being classified.

At 406 a classification model may be established for classifying the plurality of new product items. The classification model may be used within the computing environment 200 to quantify properties of the new product items by performing an algorithm or series of algorithms against the text properties (titles, description terms, images) provided in the new product item information received at 402 in order to quantify and ultimately classify the new product item relative to existing products items already in a merchant's database. Examples of classification models are: Naïve Bayes, K-Nearest-Neighbors, SVM, logistic regression, and multiclass perceptron, or the like. It should be understood that any classification model that is known or yet to be discovered is to be considered within the scope of this disclosure. It is to be contemplated that the first classification model may comprise a single algorithm or a plurality of algorithms to classify the new product item. As discussed above, the product type may influence the classification model used or established at 406 in order to optimize the method for different product types.

At 408, the system may receive a desired separation threshold that may be used by the system to determine how many of the new product items must be accurately classified at the specified accuracy percentage received at 404. The separation threshold may be a multiplier, thereby influencing the classification model during operation of the system.

At 407, in order to provide control and influence over the need for human involvement, the separation threshold may be adjusted to compensate for expected advantages and shortcomings unique to the different classification models established at 306 for differing product types. For example, the costs of human participation in the classification method must be controlled for certain low cost product items. Accordingly, the separation threshold can be set so as insure that the large majority of new product items are processed only by a machine rather than a human.

At 410, the results of the classification model are verified for accuracy. Accuracy verification may be made by testing the classification against known standards for existing product items of the same product type already within the merchant's database.

At 412, a first set of new product items is created for those items that were classified accurately at 410 as conforming to the accuracy percentage received at 404 and are above the separation threshold received at 408. At 414, a second set of new product items is created for those items that were classified accurately at 410 as conforming to the accuracy percentage received at 404 and fall below the separation threshold received at 408.

At 418, a ratio of the number of new product items in the first set over the number of new product items in the second set may be determined in order to show the effectiveness of the classification model. The ratio may also be used to estimate the amount of human involvement that will be required to reach the classification accuracy standard for the new product items.

At 419, the desired accuracy percentage may be adjusted in response to the ratio determination at 418 in order to control the need for human involvement. Additionally, accuracy expectations may be influenced, and adjusted by the classification model established at 406. As discussed above, the separation threshold may be adjusted at 407 to also aid in controlling the need for human involvement. In an implementation, both the separation threshold and the accuracy may be inter dependant and may be adjusted simultaneously to optimize human involvement for any plurality of new product items to be classified.

At 420, the second set of classifications for the new product items may be presented to a plurality of users for smart crowd source review. The smart crowd source review may be used to check the new product classifications created at 406 for accuracy and relevancy. Any smart crowd corrections may be added to the product classification and stored within memory of the computing environment 200.

It should be noted that the smart crowd users may be connected over a network, or may be located within a brick and mortar building owned by the merchant. The smart crowd users maybe employees and representatives of the merchant, or may be outsourced to smart crowd communities.

At 421, the new product item may be added to the merchant database and properly categorized relative to existing products within the merchant database based on its classification. As can be realized from the discussion above, a merchant can efficiently and cost effectively add a plurality of new product items to a merchant database in an accurate and cost controlled manner by practicing the method 400 which takes advantage of automatic classification models performed within the computing system 200 before enlisting involvement.

Additionally, the method 400 provides the ability for the advantages and short comings of certain classification models to be accounted for by making adjustments to the separation threshold for the optimized classification of differing product types.

The foregoing description has been presented for the purposes of illustration and description. It is not intended to be exhaustive or to limit the disclosure to the precise form disclosed. Many modifications and variations are possible in light of the above teaching

Further, it should be noted that any or all of the aforementioned alternate implementations may be used in any combination desired to form additional hybrid implementations of the disclosure.

Although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

1. A method for classifying new product items for addition to a merchant's database of product offerings, comprising:
receiving over a network new product information for a plurality of new product items;
receiving over a network desired accuracy percentage for classifying the plurality of new product items;
establishing a classification model within a computing environment for classifying the new product items;
classifying, within the computing environment, the new product items according to the classification model;
receiving over a computer system a desired separation threshold for the new product items;
verifying results from the classification model stored in computer memory against the separation threshold to determine classification accuracy;
creating within the computing environment a first set of new product items having classification results above the separation threshold which are deemed to be reliably classified;
creating within the computing environment a second set of new product items having classification results below the separation threshold which are not deemed to be reliably classified;
determining a ratio for the first set of new product items to the second set of new product items;
presenting over a network the second set of new product items for smart crowd source re-labeling;
receiving over a network, corrections to the results from the classification model from the smart crowd source relabeling; and
adding the first set of new product items to the merchant's database based on the results from the classification model and adding the second set of new product items to the merchant's database based on corrections to the results from the classification model from the smart crowd source relabeling.

2. A method according to claim 1, wherein the classification model is based on K-Nearest Neighbors.

3. A method according to claim 1, wherein the classification model is based on Naïve Bayes.

4. A method according to claim 1, wherein the classification model is based on logistic regression.

5. A method according to claim 1, wherein the classification model is based on support vector machines.

6. A method according to claim 1, wherein the classification model is based on multiclass perceptron.

7. A method according to claim 1, further comprising: adjusting the separation threshold relative to the classification model that is used.

8. A method according to claim 1, further comprising: selecting a classification model relative to a type of the plurality of new product items to be classified.

9. A method according to claim 8, further comprising: adjusting the separation threshold relative to the classification model that is used.

10. A method according to claim 1, adjusting the accuracy relative to the ratio of the first set of new product items to the second set of new product items.

11. A method according to claim 1, wherein the step of receiving over a computer system a desired separation threshold for the new product items, further comprising the step of receiving over a network a desired separation threshold for the new product items.

12. A system for updating a merchant database with new product items, comprising: one or more processors and one or more memory devices operably coupled to the one or more processors and storing executable and operational data, the executable and operational data effective to cause the one or more processors to:
receive new product information for a plurality of new product items;
receive a desired accuracy percentage for classifying the plurality of new product items;
establish a classification model for classifying the new product items;
receive a desired separation threshold for the new product items;
classify the plurality of new product items according to the classification model;
verify results from the classification model against the separation threshold to determine classification accuracy;
create a first set of new product items having classification results above the separation threshold which are deemed to be reliably classified;
create a second set of new product items having classification results below the separations threshold which are not deemed to be reliably classified;
determine a ratio for the first set of new product items to the second set of new product items;
present the second set of new product items for smart crowd source re-labeling;
receive corrections to the results from the classification model for the second set of new product items from the smart crowd source relabeling; and
add the first set of new product items to the merchant's database based on the results from the classification model and add the second set of new product items to the merchant's database based on corrections to the results from the classification model from the smart crowd source relabeling.

13. A system according to claim 12, wherein the classification model is based on K-Nearest Neighbors.

14. A system according to claim 12, wherein the classification model is based on Naïve Bayes.

15. A system according to claim 12, wherein the classification model is based on logistic regression.

16. A system according to claim 12, wherein the classification model is based on support vector machines.

17. A system according to claim 12, wherein the classification model is based on multiclass perceptron.

18. A system according to claim 12, further comprising: adjust the separation threshold relative to the classification model that is used.

19. A system according to claim 12, further comprising: select a classification model relative to a type of the plurality of new product items to be classified.

20. A system according to claim 19, further comprising: adjust the separation threshold relative to the classification model that is used.

21. A system according to claim 12, further comprising: adjust the accuracy relative to the ratio of the first set of new product items to the second set of new product items.
